(19) United States
(12) Patent Application Publication
(10) Pub. No.: US 2018/0374110 A1
(43) Pub. Date: Dec. 27, 2018

(54) COST-DRIVEN APPROACH TO DETERMINE INVENTORY LAYOUT IN CLOUD COMPUTING ENVIRONMENTS

(71) Applicant: VMWARE, INC., Palo Alto, CA (US)

(72) Inventors: BADARINARAYAN PARTHASARATHI BURLI, Bangalore (IN); VIKAS PRADEEP KUMAR, Bangalore (IN); VINAY KUMAR AMBLE VASANTHA, Bangalore (IN); PRAMOD CHICKABALLAPURA VASUDEVA MURTHY, Bangalore (IN)

(21) Appl. No.: 15/667,665

(22) Filed: Aug. 3, 2017

(30) Foreign Application Priority Data
Jun. 21, 2017 (IN) 201741021750

(51) Int. Cl. G06Q 30/02; G06Q 10/06

(52) U.S. Cl. CPC G06Q 30/0206; G06Q 10/0631

(57) ABSTRACT

Techniques for cost-driven approach to determine inventory layout in cloud computing environments are disclosed. In one example, a system includes a processor, and a memory coupled to the processor. The memory includes a cost-driven inventory management module to receive a cost budget for provisioning infrastructure objects in a cloud computing environment provided by at least one cloud service prosier, determine an inventory layout including a plurality of combinations of different types of infrastructure objects that are supported by the at least one cloud service provider based on the cost budget, and recommend a subset of combinations from the plurality of combinations of different types of infrastructure objects based on predetermined criteria.

### RELATED APPLICATIONS

Benefit is claimed under 35 119(a)-(d) to Foreign Application Serial No. 201741021750 filed in India entitled “COST-DRIVEN APPROACH TO DETERMINE INVENTORY LAYOUT IN CLOUD COMPUTING ENVIRONMENTS”, on Jun. 21, 2017, by VMware, Inc., which is herein incorporated in its entirety by reference for all purposes.

### TECHNICAL FIELD

The present disclosure relates to a cloud computing environment and, more particularly, to determine inventory layout including a plurality of combinations of different types of infrastructure objects in the cloud computing environment based on an allocated cost budget.

### BACKGROUND

In cloud computing design, numerous tools exist to create and deploy applications (e.g., applications including one or more virtual machines (VMs) connected to each other in a particular topology) in cloud environments. For example, application provisioning tools facilitate cloud computing designers to create and standardize application deployment topologies on infrastructure clouds. Some application provisioning tools include graphical user interfaces (GUIs) that enable designers to generate application deployment topologies called application blueprints, which define structures and configurations of applications. Once a blueprint is designed to define an application, the blueprint can be used to deploy multiple instances of the application to many cloud environments. VMware vRealize Automation® can automate the delivery of personalized infrastructure (e.g., central processing unit (CPU), memory, and storage), applications and custom information technology (IT) services using the blueprints. Au administrator can deploy multiple instances of the application using already created blueprints without a need to specify the configuration properties.

Further, cost management tools may automate cloud costing, consumption analysis and comparison, delivering the insight to efficiently deploy and manage cloud environments. However, such cost management tools may provide these functionalities when the infrastructure is added as an endpoint in the cloud.

### BRIEF DESCRIPTION OF THE DRAWINGS

FIG. 1 is a block diagram of an example system for determining an inventory layout including a plurality of combinations of different types of infrastructure objects based on a given cost budget;

FIG. 2 is a block diagram illustrating virtualized server with which one or more embodiments of the present disclosure may be utilized;

FIG. 3 is an example system illustrating example information flow for calculating a cost of a VM;

FIG. 4 illustrates a flow diagram of an example method for determining an inventory layout including a plurality of combinations of different types of infrastructure objects based on a given cost budget;

FIG. 5 illustrates a flow diagram of an example method to determine a number of instances of applications/VMs of various blueprints to be provisioned on existing infrastructure based on a given cost budget;

FIG. 6 illustrates a flow diagram of an example method to determine comprehensive combinations of allocations of instances of VMs of various blueprints/profiles on different servers in the reference database based on a given budget; and

FIG. 7 is a block diagram of an example server including a non-transitory computer-readable storage medium storing instructions to determining a plurality of combinations of different types of infrastructure objects based on a given cost budget.

The drawings described herein are for illustration purposes only and are not intended to limit the scope of the present subject matter in any way.

### DETAILED DESCRIPTION

Embodiments described herein may provide an enhanced computer-based and network-based method, technique, and system for determining inventory layout including a plurality of combinations of different types of infrastructure objects in the cloud computing environment based on a given cost budget. In a cloud computing environment, a management server may communicate with multiple clients, with each client associated with resource reservations to accommodate applications (e.g., virtual machines (VMs)). A client may be an entity, such as a business, that may be organized in various departments or business units. Each department may use different computing resources of a data center. The data center then may charge the entity by department. For example, a bill may be generated detailing charges per department.

In using the cloud computing environment, a client may instantiate a number of VMs in a virtual infrastructure. The virtual infrastructure may be a listing of departments and which VMs have been instantiated by each department. A configuration may be used to specify computing resources that are desired. For example, the configuration may include types of computing resources (e.g., a computer system/server with a certain processing speed) or fixed levels of service that can be provided. A data center administrator is a user who configures costs for using the computing resources of the data center. The data center administrator may assign a cost to a VM based on the desired configuration. For example, based on the type of computing resources requested, the data center administrator assigns the cost to the VM.

Cost management tools (e.g., vRealize Business for Cloud (vRBC), a VMware product that delivers Information Technology (IT) cost data) may automate cloud costing, consumption analysis and comparison, delivering the insight to efficiently deploy and manage cloud environments. Cost management tools may be oriented towards helping the clients to arrive at costing once provisioned on the cloud or associated private software data center. Alternatively, costing can also be determined when the process of commissioning starts and the IT administrators understand the composition of VMs (e.g., based on what has been provisioned or will be provisional) and apply the cost to each component of VMs and then provide overall costing. These applications or products work as metering software. An example of software that provides cost management includes:
VMware vRBC: A set of vRealize Business for cloud capabilities helps IT administrators to assess private and public cloud costs, optimize these, costs, and allocate them to IT customers (i.e., clients). vRBC takes minutes to deploy and, right out of the box, users can analyze private cloud expenses broken down by cost drivers (i.e. hardware, operating system OS), maintenance, labor, facilities, and the like), server clusters, VMs, and IT customers. In addition, users can analyze public cloud. expenses, policy driven pricing for VMs and compare cost and efficiency between private and public cloud deployment options.

However, such cost management tools may provide these functionalities when the infrastructure is added as an endpoint in the product. Infrastructure commissioning and capacity planning related decisions can be taken based on cost budget. Therefore, administrators may look for below information before provisioning the infrastructure objects (e.g., servers, datastores, applications, and the like) in the cloud.
Administrators may look for the cost of provisioning “N” number of of machines of a particular profile (e.g., based on CPU, random-access memory (RAM), storage and OS) on a specific server or cloud vendor, without provisioning a machine.
What are better alternatives for a server (in comparison to what administrators already have) given the budget and the requirement for number of machines. For example,
   Is PowerEdge better than Cisco in terms of budget given (assuming similar server configuration) and requirement for number of machines?
   Is Amazon Web Services™ (AWS) better than commissioning our own infrastructure given the budget and capacity requirements?
How many machines of a specific configuration can be supported h different types of servers or cloud vendors under the constraint of budget?
In case where administrators already have some servers, given a budget, how many more machines of a specific configuration can be accommodated on the existing infrastructure?
Administrators are using a cloud automation product that maintains a blueprint or profile for each kind of machine (i.e., information about CPU, RAM and storage). Administrators may want to know the combinations of instances of blueprints or profiles that can be provisioned on the infrastructure given the budget.

Examples described herein may provide a different combinations of inventory layout that can be, provisioned, on multiple cloud vendors and servers, given a budget, savings, profit margin or cost. In one example:
Given a budget and blueprint, examples described herein may provide different combinations of the instances of blueprint or machine profile that can be provisioned on an existing infrastructure bed and. can suggest the best combinations based on predetermined criteria.
Given a budget, examples described herein may provide combinations of different infrastructure that can support the capacity needs and can suggest the top ‘N’ combinations based on predetermined criteria.

Examples disclosed herein may be implemented in connection with cloud computing environments that use VMs and/or containers. A VM is a data computer node that operates with its own guest operating system (OS) on a host using resources of the host virtualized by virtualization software. A container is a data computer node that runs on top of a host OS without the need for a hypervisor or separate OS.

### System Overview and Examples of Operation

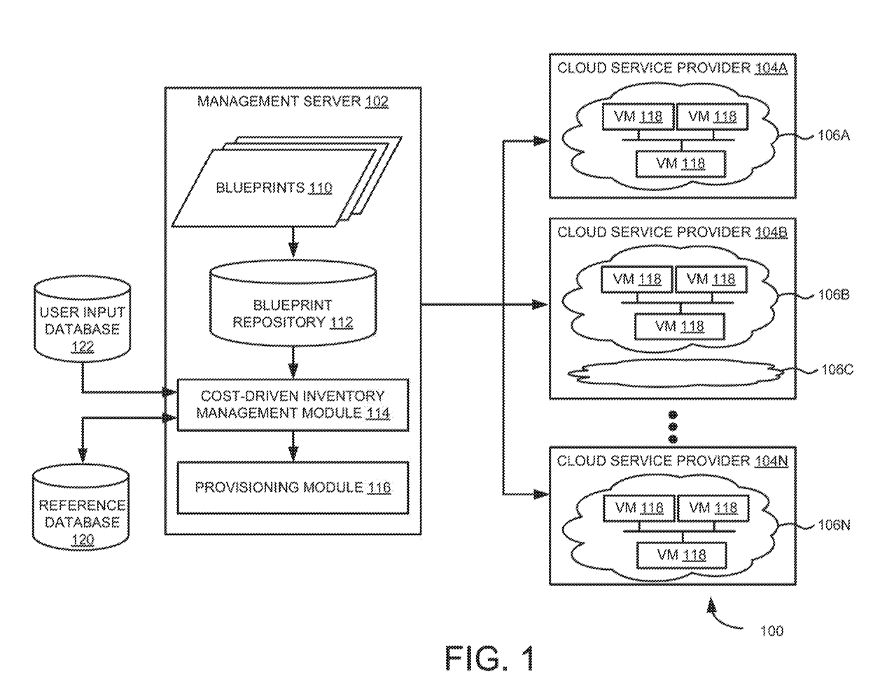

FIG. 1 is a block diagram of an example system 100 for determining an inventory layout including a plurality of combinations of different types of infrastructure objects in a cloud computing environment based on a given cost budget. Cloud computing environment (e.g., virtualized cloud computing, environment) may include one or more, computing platforms that support the creation, deployment, and management of VM-based cloud applications. One such platform is the vRealize Automation®, which is commercially available from VMware. While vRealize Automation is one example of a cloud deployment platform, it should be noted that any computing platform that supports the creation and deployment of virtualized cloud applications is within the scope of the present invention.

As shown in FIG. 1, system 100 may include a management server 102 and cloud service providers 104A-N that are in communication with management server 102. Management server 102 may refer to a computing device, or computer program (i.e., executing on a computing device), that provides some service to clients of the cloud service providers 104A-104N. Management server 102 may connect to the cloud service providers 104A-N either directly or over a network (e.g., over a local-area network, wide-area network, wireless network, or the like).

Each client may be associated with a resource reservation to support application operations. Example client may be a customer, business group, tenant, an enterprise, and the Like. A resource reservation may allocate a share of the memory, CPU and storage resources on one or more computing resources for a client to use. For example, clients may be provisioned with resource reservations to provide corresponding deployment environments 106A-N in which clients can deploy their applications (e.g., multi-tier applications). Deployment environments 106A-N may be provided by cloud service providers 104A-N.

In one example, a multi-tier application created by a developer is being deployed for an enterprise in a deployment environment 106 provided by cloud service providers 104A-N. As depicted in FIG. 1, each cloud service provider 104 may provide one or more deployment environments 106, for example, for development, testing, staging, and production of the application. The enterprise may access services from cloud service provider 104, for example, via REST (Representational State Transfer) APIs (Application Programming Interface) or any other client-server communication protocol. One particular implementation of a REST API for cloud computing services is vCloud Director API available from VMware, Inc. Cloud service provider 104 provisions virtual computing resources (e.g., VMs 118) to provide a deployment environment 106 in which the enterprise can deploy its multi-tier application.

In cloud computing environments, a number of VMs can be created for each client and resources (e.g., CPU, memory, storage, and the like) may be allocated for each VM to support application operations. In some examples, a VM is an emulation of a particular computer system that operates based on a particular computer architecture, while functioning as a real or hypothetical computer. VM implementations may involve specialized hardware, software, or a combination of both. In the illustrated example of FIG. 1, an application runs on an example VM 118 in deployment environment (e.g., 106A) corresponding to client (e.g., 104A). Thus, in FIG. 1, VMs 118 are depicted as instantiated in the cloud computing environment by management server 102. Note that management server 102 instantiates VMs 118 upon being requested to do so.

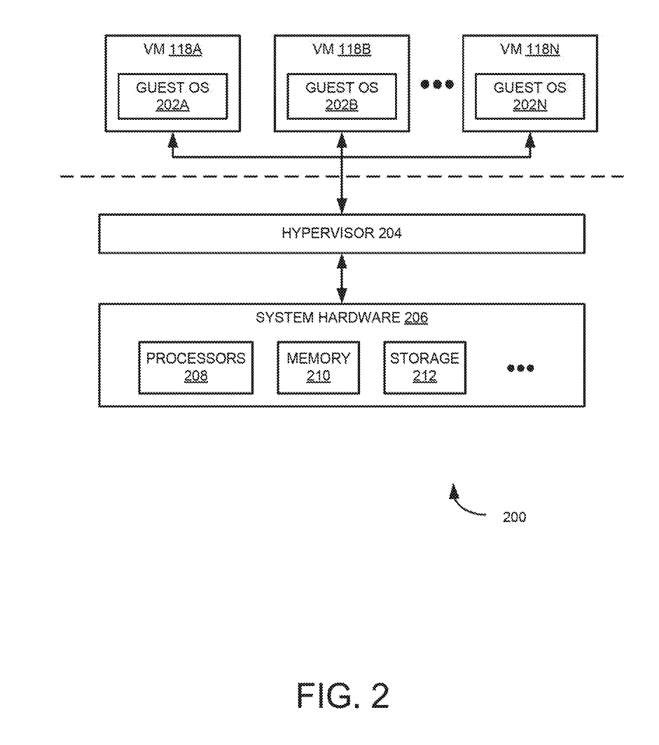

Referring now to FIG. 2, which is a block diagram illustrating an example virtualized server 200 (i.e., virtualized computer system) with which one or more embodiments, of the present disclosure may be utilized. VMs 118A-N may be provisioned to provide a deployment environment 106 in which a client can deploy its multi-tier application. VMS 118A-N may include respective guest operating systems (OS) 202A-N and virtualized system hardware, which includes one or more virtual CPUs. virtual system memory, one or more virtual disks, one or more virtual devices, etc., all of which are implemented in software to emulate the corresponding components of an actual host computer. Guest OS 202A-N included in each VM 118 includes a file system, which stores various files and libraries associated with applications that are running on guest OS 202A-N.

VMs 118A-N run on top of a hypervisor 204, which is a software interface layer that abstracts system hardware 206 into virtualized hardware, thereby enabling sharing of system hardware 206 of server 200 amongst VMs 118. Hypervisor 204 acts as an interface between VMs 118A-N and system hardware 206 for executing, VM-related instructions and for transferring data to and from machine memory 210, processor(s) 208, storage 212, and the like. It should be recognized that system hardware 206 also includes, or is, connected to, registers, interrupt handling circuitry, a clock, memory management unit (MMU), a network interface, and the like, which, for the sake of simplicity, are not shown in the figures. Hypervisor 204 may run on top of an operating system of server 200 or directly on hardware components of server 200.

Referring, to FIG. 1, management server 102 may include blueprints 110. Blueprints 110 can be mapped to corresponding ones of clients. For example, an administrator uses an associated computing device to access management server 102 to create blueprints 110 that can be entitled to users in a specific client. For example, blueprints 110 can be either specific to a business group or shared among business groups in a tenant. In embodiments, the blueprint may specify how the application is to be deployed to a cloud infrastructure. In order to specify how a multi-tiered application (i.e., an application comprising multiple virtual machines) is to be deployed, the blueprint may specify the number of virtual machines to be deployed, the characteristics of each virtual machine (e.g., the amount of RAM, the amount of storage, and the number of CPUs for each virtual machine), the system or application software that is to be installed on each virtual machine, and the order in which each virtual machine is to be deployed.

In other examples, blueprints 110 can be created using service templates to use a same blueprint to deploy different instances of an application using services that are different between the instances of the application. In some examples, different deployment profiles are configured based, on the same application blueprint to deploy the applications using different services fir each of the example applications. Further, the blueprints 110 can be stored in a blue print repository 112. For example, when a client's member requests a VM, the VM can be provisioned according to the specifications in the blueprint. An example of a blueprint may specify a Windows 7 developer workstation with one CPU, 2 GB of memory, and a 30 GB hard disk.

In one example, management server 102 may include a cost-driven inventory management module 114. Cost-driven inventory management module 114 can be a part of management software residing in memory of management server 102. During operation, cost-driven inventory management module 114 may receive a cost budget for provisioning infrastructure objects in a cloud computing environment provided by at least one cloud service provider 104.

Further, cost-driven inventory management module 114 may determine an inventory layout including a plurality of combinations of different types of infrastructure objects that are supported by the at least one cloud service provider 104 based on the, cost budget. Example infrastructure objects may include servers, applications, or a combination thereof. Example server may include physical resources selected from a group consisting of CPUs, memory, storage, and network resources. Example applications may include VMs.

In one example, cost-driven inventory management module 114 may determine a capital cost and/or an operational cost associated with each of the different types of infrastructure objects based on a fully loaded cost of a cluster, direct VM cost, and storage cost. The fully loaded cost of the cluster, the direct VM cost, and the storage cost can be provided as an input from a user (i.e., user input database 122) and/or read from a reference database 120. The fully loaded cost of the cluster may include price per gigahertz (Ghz) of CPUs, price per gigabyte (GB) of RAM, hardware cost, network cost, facilities cost, any other additional cost, or any combination thereof The direct VM cost may include operating system (OS) cost, VM labor cost, OS labor cost, backup cost or any combination thereof. The storage cost is a percentage of the GB that is required by VMs. Facilities may refer to real estate costs, particularly, the cost of data center buildings or rent, power costs, cooling costs, racks, and associated facility management labor. Facility related costs except power are encapsulated into the rent price per rack unit. Power costs come from applying power rates (price/kWh) to power consumption measured in vCenter, which is commercially available from VMware. Example network cost may be estimated as a product of suggested price per network port and the number of ports on the server. Additional costs may include costs related to backup, disaster recovery, security, and the like.

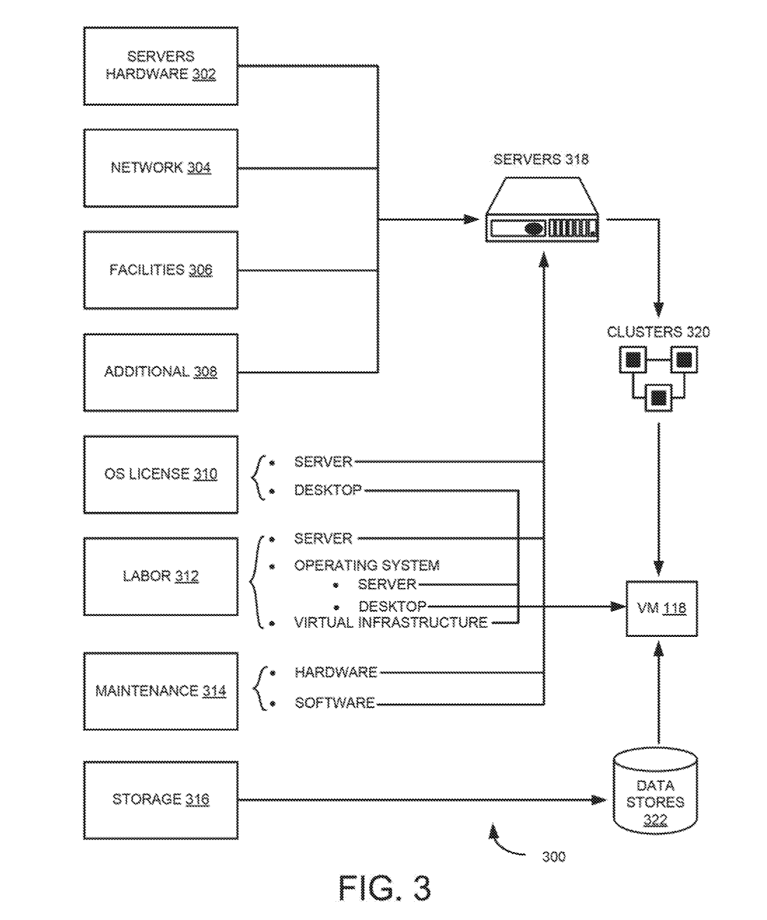

FIG. 3 is an example system 300 illustrating example information flow for calculating a cost of a VM. Cost management tools, such as vRBC, internally maintains two logical spaces in database. One space is a reference database 120 to store reference values for different hardware, network, storage, facilities cost configuration as collected from vRBC telemetry over the period of time from multiple customers. Another space is a user input database 122 designed to store user inputs for the costs of rates at which services or infrastructure needs to be charged. For any information required, cost-driven inventory management module 114 may first explores the user input database 122 and if the information is not available, then the cost-driven inventory management module 114 considers reference database 120 for the required information. In some examples, user input database 122 is preferred first, and when the information is not available in the user input database 122, then the reference database 120 is considered. Also, in some examples, user input database 122 may reference to the reference database 120 for some of the required information.

FIG. 3 shows the example information flow of vRBC in calculating the cost (i.e., capital cost and operational cost) of a VM 118. Information flow of vRBC may involve three elements:
1. Fully loaded cost of cluster: This cost is calculated per cluster. Each cluster 320 may have more than one server hence this cost takes all servers 318 under a cluster 320 into account. The algorithm calculates price per Ghz for CPU and price per GB for RAM by reading expected utilization from vRealize Operations offered by VMware in real time and/or from reference database 120. Hardware cost (e.g., 302) and network cost (e.g., 304) are calculated from reference database 120. Facilities cost (e.g., 306) and additional cost (e.g., 308) are either read from user input space in user input database 122 and when these costs are not available, then these costs are read from reference database 120.
2. Direct VM cost: This cost is an aggregation of four elements: OS cost (e.g., 310), labor cost 312 (e.g., VM labor cost, OS labor cost) and backup cost (e.g., maintenance cost 314 including server hardware maintenance cost and OS maintenance cost). These costs are first read from user input space in user input database 122 and when these costs are not available, then these costs are read from reference database 120.
3. Storage cost: Storage cost (e.g., 316) is x % of the GB, available in datastores 322, that is required by the VM 118. The value of x is either provided as input from user and/or consulted from reference database 120.

Further, cost-driven inventory management module 114 may determine the inventory layout including the plurality of combinations of different types of infrastructure objects based on a comparative analysis of the capital cost and/or the operational cost associated with each of the different types of infrastructure objects. The plurality of combinations of different types of infrastructure objects supported by the at least one cloud service provider is determined by performing a simple ratio approach, rotating priority approach or a combination thereof on the different types of infrastructure objects based on the cost budget, the capital cost and/or the operational cost as shown below.
1. Simple Ratio: In this simple ratio approach, the cost budget is allocated amongst different blueprints. If ‘N’ different kinds of blueprints are available, the simple ratio approach can produce (2̂N−1) combinations.
2. Rotating Priority: In the rotating priority approach, each of ‘N’ different machine blueprints are assigned a priority from 1 . . . N, where 1 signifies highest priority and N signifies lowest priority. Combinations are generated using such a priority assignment. After generating combinations, the priorities are shifted in such a way that each of the N machine blueprints or profiles is assigned all priorities from 1 . . . N. The rotating priority approach can produce N! combinations.

In one example, cost-driven inventory management module 114 may determine the inventory layout including the plurality of combinations of different types of physical infrastructure that are supported by the at least one cloud service provider based on the cost budget. The different types of physical infrastructure include different types of servers and associated, versions to provide cloud computing services for applications running therein. The plurality of combinations of different types of infrastructure is determined by performing a comparative analysis of vendors providing the different types of servers based on the cost budget.

In another example, cost-driven inventory management module 114 may determine the inventory layout including a plurality of combinations of instances of application blueprints that can be provisioned on existing infrastructure in the cloud computing environment by the at least one cloud service provider based on the cost budget. The existing infrastructure include servers and associated versions provided by one or more vendors.

Furthermore, cost-driven inventory management module 114 may recommend a subset of combinations from the plurality of combinations of different types of infrastructure objects based on predetermined criteria. In one example, cost-driven inventory management module 114 may de-duplicate the plurality of combinations, determine the subset of combinations from the de-duplicated plurality of combinations based on the predetermined criteria, and then recommend. the determined subset of combinations. The predetermined criteria may be selected from a group consisting of a predetermined priority, infrastructure utilization, and hybrid server configuration.

Management server 102 includes a provisioning module 116, which can be implemented as a pan of management software residing in management server 102. provisioning module 116 may provision the infrastructure objects in the cloud computing environment based on selection of one of the subset of combinations in accordance with the recommendation. In one example, the selection may be received from a member (e.g., administrator, manager, user, and the like) of the client. For example, the member may select a recommendation, which includes one or more blueprints and a number of instances of each blueprint to deploy the application. In one example, upon receiving the selection, provisioning module 116 may instruct cost-driven inventory management module 114 to suspend an modifications to the resources allocated to the client, for instance, until the provisioning request is served.

Examples described herein to determine the inventory layout that can easily scale up to the required service standards of the IT administrators may involve reverse engineering cost calculation process. While vRBC calculates the cost of a VM of a particular blueprint given the infrastructure attached to the VM in the form of endpoint, examples, described herein may reverse engineer the process and find out the instances of a VM of a particular blueprint that can be provisioned on a particular kind of infrastructure, given the budget. Additionally, the reference database 120 of vRBC may enable to bring out a comprehensive comparative list of number of VMs of a particular blueprint that can be provisioned on different infrastructure and server combinations, given the budget. In these examples, the cost or the budget is driving factor in determining what infrastructure or cloud vendor can be used to provision VMs, instead of commissioning the inventory and then determining costs on the go based on usage.

Examples described herein may be implemented in a cloud computing environment where a set of resources may be allocated to one or more clients. In one example, management server 102 may comprise the vCenter Server™ and vSphere® program products, which are commercially available from VMware, Inc. An example of cost-driven inventory management module 114 and provisioning module 116 can be implemented in vRealize Automation®, vRealize Operations, vRBC, and/or the like that are offered by VMware. Cost-driven inventory management module 114 and provisioning module 116 can be implemented in infrastructure as a Service (IaaS), which is a component that enables the provisioning of virtualized infrastructure components in a cloud-based computing environment. In other examples, any other suitable cloud computing platform may be used to implement cost-driven inventory management module 114 and provisioning module 116.

In one example, cost-driven inventory management module 114 and provisioning module 116 residing in management server 102 may be implemented as engines or modules comprising any combination of hardware and programming to implement the functionalities described herein. Each of cost-driven inventory management module 114 and provisioning module 116 can be a service process in the virtual center or can be an appliance running in the data center to cater multiple virtual centers in a cloud based environment.

In some examples, the functionalities described herein, in relation to instructions to implement functions of cost-driven inventory management module 114 and provisioning module 116 and any additional instructions described herein in relation to the storage medium, may be implemented as engines or modules comprising any combination of hardware and programming to implement the functionalities of the modules or engines described herein. The functions of cost-driven inventory management module 114 and provisioning module 116 may also be implemented by respective processor. In examples described herein, the processor may include, for example, one processor or multiple processors included in a simile device or distributed across multiple devices.

The embodiments described also can be practiced without some of the specific details described herein, or with other specific details, such as changes with respect to the ordering of the logic, different logic, different architectures, or the like. Thus, the scope of the techniques and/or functions described is not limited by the particular order, selection, or decomposition of aspects described with reference to any particular routine, module, component, or the like.

### Example Processes

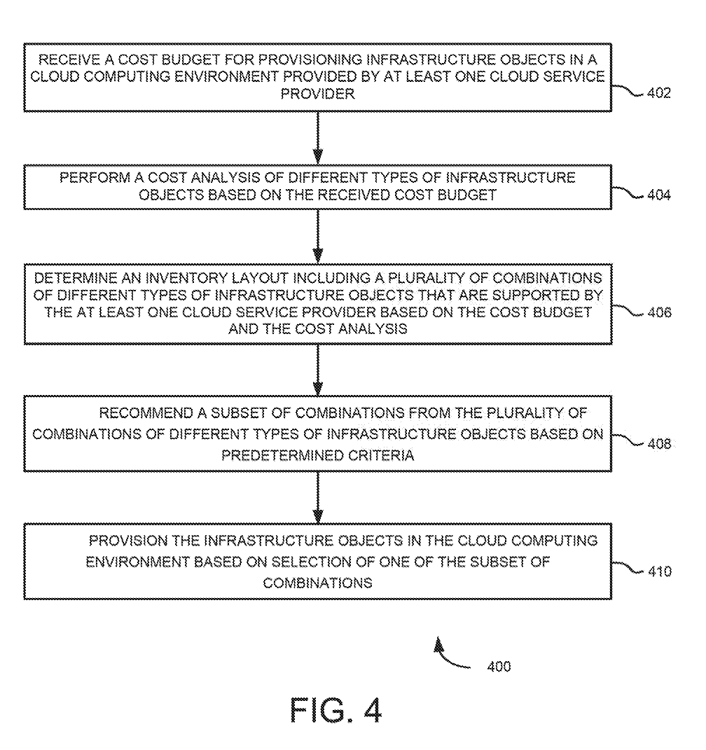

FIG. 4 illustrates a flow diagram 400 of an example cost-driven method for determining an inventory layout including a plurality of combinations of different types of infrastructure objects. It should be understood that the process depicted in FIG. 4 represents generalized illustrations, and that other processes may be added or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 402, a cost budget is received for provisioning infrastructure objects in a cloud computing environment provided by at least one cloud service provider, in one example, the cost budget may be allocated by a client customer, business, and the like) of the cloud service provider.

At 404, a cost analysis of different types of infrastructure objects is performed based on the received cost budget. Example infrastructure objects may include servers, applications, or a combination thereof Example server may include physical resources selected from a group consisting of a central processing unit (CPU), memory, storage, and network resources. Example applications may include VMs. In one example, a capital cost and/or an operational cost associated with each of the different types of infrastructure objects is determined based on a fully loaded cost of a cluster, direct VM cost, and storage cost. The fully loaded cost of the cluster, the direct VM cost, and the storage cost are provided as an input from a user and/or read from a reference database.

At 406, an inventory layout including a plurality of combinations of different types of infrastructure objects that are supported by the at least one cloud service provider is determined based on the cost budget and the cost analysis. Further, the inventory layout including the plurality of combinations of different types of infrastructure objects is determined based on the cost analysis of the capital cost and/or the operational cost associated with each of the different types of infrastructure objects with respect to the allocated cost budget.

In one example, determining the inventory layout including a plurality of combinations of different types of physical infrastructure that are supported by the at least one cloud service provider based on the cost budget. For example, different types of physical infrastructure may include different types of servers (i.e., new servers) and associated versions to provide cloud computing services for applications running therein. Further, the inventory layout including a plurality of combinations of instances of application blueprints that can be provisioned on the different types of servers by the at least one cloud service provider is determined based on the cost budget. The different types of servers can be provided by different vendors.

For example, a server price may depend on many different factors including how many and what CPUs are included in the server, how much RAM is included in the server, what other components such as hard disks, network and storage cards are in the server, and so on. Servers come in different firm (e.g. rack mounted, tower, blade, desktop, and the like), different size, different power consumption, and come with or without OS installed.

In another example, the inventory layout including a plurality of combinations of instances of application blueprints that can be provisioned on existing infrastructure in the cloud computing environment by the at least one cloud service provider is determined based on the cost budget. The existing infrastructure may include servers provided by one or more vendors and allocated to a specific client.

At 408, a subset of combinations from the plurality of combinations of different types of infrastructure objects are recommended/provided on a graphical user interface based on predetermined criteria. At 410, the infrastructure objects are provisioned in the cloud computing environment based on selection of one of the subset of combinations in accordance with the recommendation. In ore example, one of the subset of combinations may be selected by the client of the cloud service provider. The cost-driven method for determining an inventory layout is explained in more detail with reference to FIGS. 1-3.

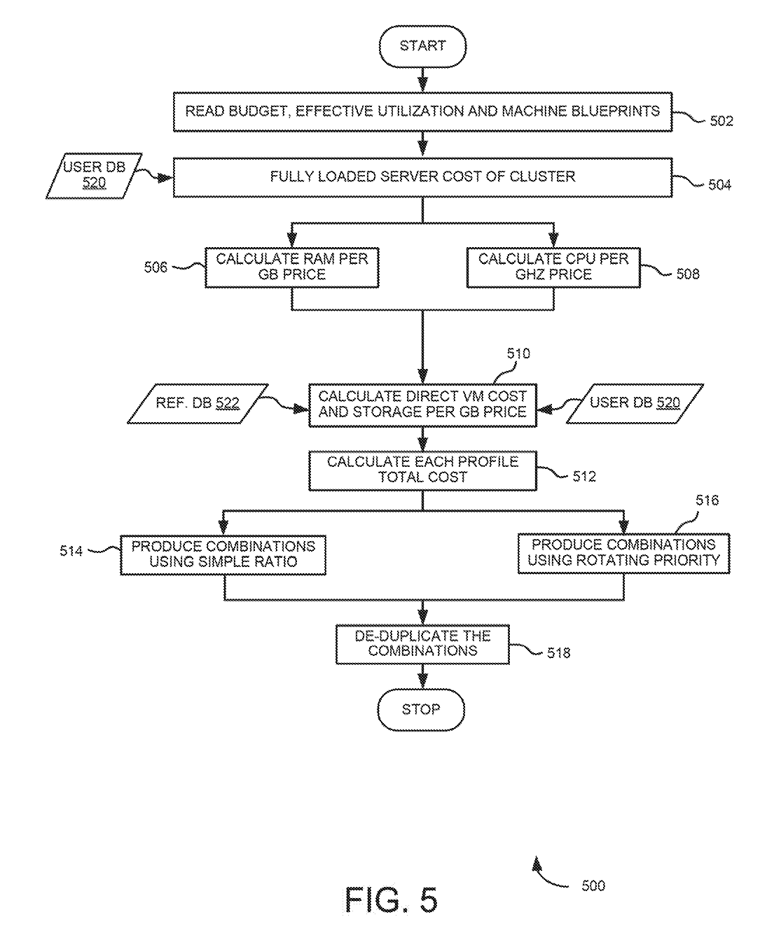

FIG. 5 illustrates a flow diagram 500 of an example method to determine a number of instances of applications/VMs of various blueprints to be provisioned on existing infrastructure based on a given cost budget. At 502, cost budget, machine blueprints, and expected utilization may be read from a user input database 520 and/or a reference database 522.

At 504, a fully loaded cost of the cluster may be read from a database (e.g., user database 520) (e.g., as calculated by vRBC). At 506 and 508, the RAM price per GB and the CPU price per GHz may be calculated respectively, as per procedures mentioned below:

Determining price/GHz for CPU using vRBC
1: Read expected utilization.
2: For each server in a cluster,
   a. Determine the cost per CPU from the reference database 522.
   b. Calculate the total GIL as summation of number of CPUs*number of core per CPU*GHz per core.
   c. Calculate the total CPU cost as summation of cost per CPU number of CPUs,
   d. Calculate the CPU percentage of cost as total CPU cost (total CPU cost+total RAM cost).
3: Calculate the total cluster cost as summation of fully loaded monthly cost of all servers.
4: Calculate the relative CPU cost as total cluster cost CPU percentage of cost.
5: Calculate effective GHz as total GHz*expected utilization.
6: Calculate price per effective GHz as relative CPU cost effective GHz.

Determining price/GB for RAM using vRBC
1: Read expected utilization.
2: For each server in a cluster,
   a. Determine the RAM cost per GB from reference database 522.
   b. Calculate the Total GB as summation of RAM GB for all servers.
   c. Calculate the total RAM cost as summation of RAM cost per GB*total GB.
   d. Calculate the RAM percentage of cost as total RAM cost/(total CPU cost+total RAM cost).
3: Calculate the total cluster cost as summation of fully loaded monthly cost of all servers.
4: Calculate the relative RAM cost as total cluster cost*RAM percentage of cost.
5: Calculate effective GB as total GB*expected utilization.
6: Calculate price per effective GB as relative RAM cost/effective GB.

At 510, the direct VM cost is calculated from the reference database 522 as mentioned in the below example. In one example, the direct VM cost is calculated using information stored in the user input space (e.g., 520) and if the information is not available, then the reference database 522 is consulted for the required information.

Determining direct VM cost for a given OS using vRBC
1: Read OS type as x.
2: Determine the OS cost from reference database 522 for x.
3: Determine the VM labor cost from reference database 522 for x.
4: Determine the OS labor cost from reference database 522 for x.
5: Determine the backup cost from reference database 522 for x.
6: Calculate the direct VM cost by aggregating the cost obtained from step 2 to step 5.

Further at 510 the application/VM blueprints are read and the storage cost of each profile is calculated from the reference database 522. At 512, the total cost of each profile is calculated by using steps 506, 508, and 510. At 514 and 516, the simple ratio and rotating priority may be used to produce combinations of number of instances of a particular blueprint or profiles. At 518, the combinations are de-duplicated. De-duplication is a data compression technique for eliminating duplicate copies of repeating combinations.

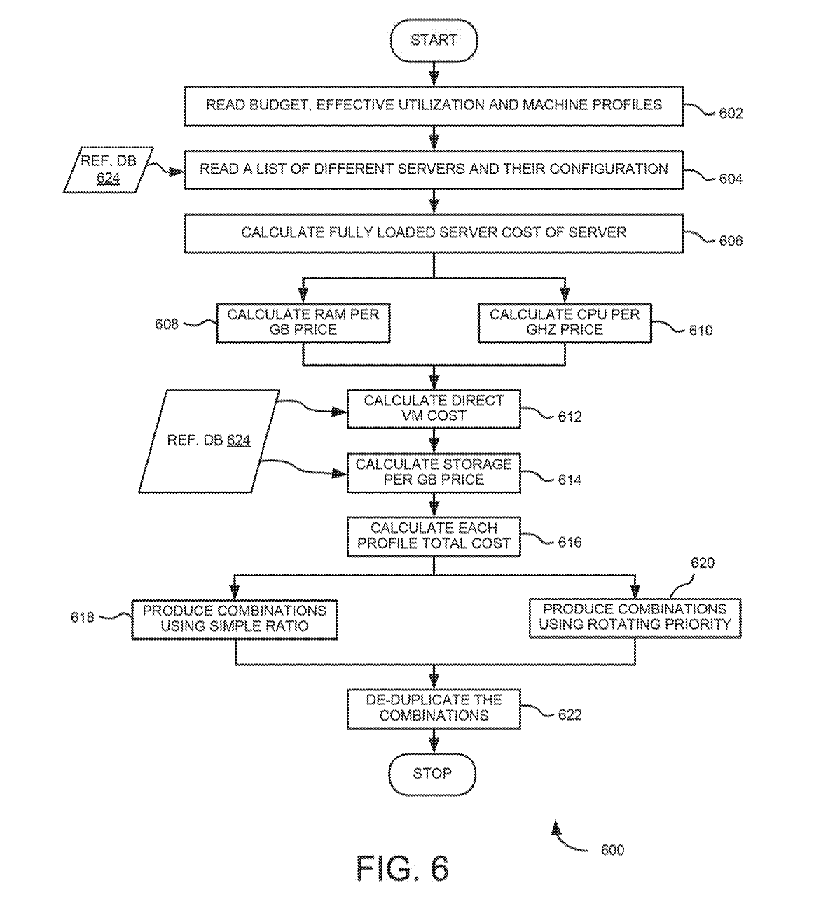

FIG. 6 illustrates a flow diagram 600 of an example method to determine comprehensive combinations of allocations of instances of VMS of various blueprints/profiles on different servers in the reference database 624 based on a given budget. At 602, cost budget, machine blueprints, and expected utilization may be read from a user input database and/or a reference database 624. At 604, the list of different servers and their configuration (e.g., CPU, RAM, storage, network, and the like) are read from the reference database 624. Further, steps 606 to 622 are performed for each server. At 606, a fully loaded cost of the cluster is calculated for a particular sever assuming that the cluster has only this server. At 608 and 610, the RAM price per GB and the CPU price per GHz may be calculated respectively, as per procedures mentioned in FIG. 5.

At 612, the direct NW cost is calculated from the reference database 624 as mentioned in FIG. 5. At 614, the application/VM blueprints are read and the storage cost per GB of each profile is calculated from reference database 624. At 616, the total cost of each profile is calculated by using steps 608, 610, 612, and 614. At 618 and 620, the simple ratio and rotating priority may be used to produce combinations of number of instances of a particular blueprint or profiles. At 622, the combinations are de-duplicated. De-duplication is a data compression technique for eliminating duplicate copies of repeating combinations. In one example, for the combinations produced using above methods, IT administrators can apply individual criteria (e.g., utilization, hybrid server configuration and the like) to select a best combination from the de-duplicated combinations.

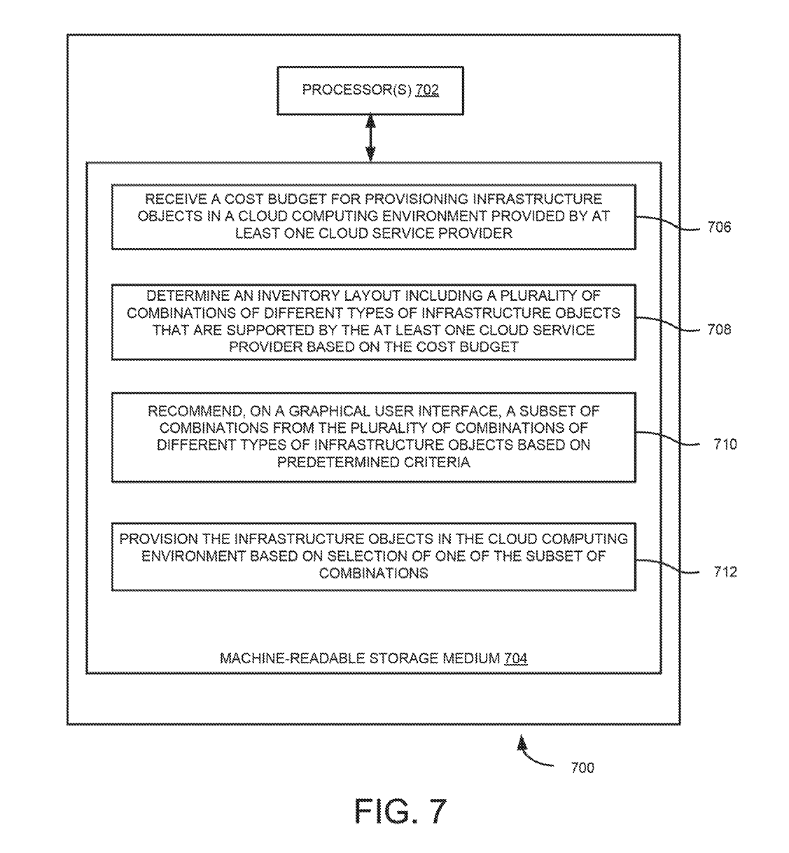

FIG. 7 is a block diagram of an example server 700 including a non-transitory computer-readable storage medium storing instructions to deploy instances of the application based on service catalogs. Server 700 (e.g., management server 102 of FIG. 1) includes a processor 702 and a machine-readable storage medium 704 communicatively coupled through a system bus. Processor 702 may be any type of central processing, unit (CPU), microprocessor, or processing logic that interprets and executes machine-readable instructions stored in machine-readable storage medium 704. Machine-readable storage medium 704 may be a RAM or another type of dynamic storage device that may store information and machine-readable instructions that may be executed by processor 702. For example, machine-readable storage medium 704 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, the machine-readable storage medium 704 may be a non-transitory machine-readable medium. In an example, machine-readable storage medium 704 may be remote but accessible to server 700.

Machine-readable storage medium 704 may store instructions 706-712 that can be executed by processor 702. Instructions 706 may be executed by processor 702 to receive a cost budget for provisioning infrastructure objects in a cloud computing environment provided by at least one cloud service provider. Instructions 708 may be executed by processor 702 to determine an inventory layout including a plurality of combinations of different types of infrastructure objects that are supported by the at least one cloud service provider based on the cost budget. Instructions 710 may be executed by processor 702 to recommend, on a graphical user interface, a subset of combinations from the plurality of combinations of different types of infrastructure objects based on predetermined criteria. Instructions 712 may be executed by processor 702 to provision the infrastructure objects in the cloud computing environment based on selection of one of the subset of combinations in accordance with the recommendation.

Some or all of the system components and/or, data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques. Some or all of the components and/or data structures may be stored on tangible, non-transitory storage mediums. Some or all of the system components and data structures may also be provided as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown arid described with reference to the foregoing examples. It is understood, however, that other forms, details, and examples can be made without departing from the spirit and scope of the present subject matter that is defined in the following claims.

What is claimed is:

1. A system comprising:
a processor; and
a memory coupled to the processor, wherein the memory includes a cost-driven inventory management module to:
receive a cost budget fir provisioning infrastructure objects in a cloud computing environment provided by at least one cloud service provider;
determine an inventory layout including a plurality of combinations of different types of infrastructure objects that are supported by the at least one cloud service provider based on the cost budget; and
recommend a subset of combinations from the plurality of combinations of different types of infrastructure objects based on predetermined criteria.

2. The system of claim 1, further comprising:
a provisioning module to provision the infrastructure objects in the cloud computing environment based on a selection of one of the subset of combinations in accordance with the recommendation.

3. The system of claim 1, wherein the infrastructure objects comprise servers, applications, or a combination thereof, wherein each server comprises physical resources selected from a group consisting of a central processing unit (CPU), memory, storage, and network resources, and wherein the applications comprise virtual machines (VMs).

4. The system of claim 1, wherein the cost-driven inventory management module is to:
determine the inventory layout including a plurality of combinations of different types of physical infrastructure that are supported by the at least one cloud service provider based on the cost budget, wherein the different types of physical infrastructure comprise different types of servers and associated versions to provide cloud computing services for applications running therein.

5. The system of claim 4, wherein the plurality of combinations of different types of infrastructure is determined by performing a comparative analysis of vendors providing the different types of servers based on the cost budget.

6. The system of claim 1, wherein the cost-driven inventory management module is to:
determine the inventory layout including a plurality of combinations of instances of application blueprints that can be provisioned on existing infrastructure in the cloud computing environment by the at least one cloud service provider based on the cost budget, wherein the existing infrastructure comprises servers and associated versions provided by one or more vendors.

7. The system of claim 1, wherein determining the inventory layout including the plurality of combinations of different types of infrastructure objects comprises:
determining a capital cost and/or an operational cost associated with each of the different types of infrastructure objects based on a fully loaded cost of a cluster, direct VM cost, and storage cost; and
determining the inventory layout including the plurality of combinations of different types of infrastructure objects based on a comparative analysis of the capital cost and/or the operational cost associated with each of the different types of infrastructure objects.

8. The system of claim 7, wherein the fully loaded cost of the cluster comprises price per gigahertz (Ghz) of central processing units (CPUs), price per gigabyte (GB) of random-access memory (RAM), hardware cost, network cost, facilities cost, additional cost, or any combination thereof, and wherein the direct VM cost comprises operating system (OS) cost, VM labor cost, OS labor cost, backup cost or any combination thereof, and wherein the storage cost is a percentage of the GB that is required by VMs.

9. The system of claim 7, wherein the fully loaded cost of the cluster, the direct VM cost, and the storage cost are provided as an input from a user and/or read from a reference database.

10. The system of claim 1, wherein recommending the subset of combinations from the plurality of combinations of different types of infrastructure objects based on predetermined criteria, comprises:
de-duplicating the plurality of combinations and
determining the subset of combinations from the de-duplicated plurality of combinations based on the predetermined criteria, wherein the predetermined criteria is selected from a group consisting at a predetermined priority, infrastructure utilization, and hybrid server configuration.

11. The system of claim 1, wherein the plurality of combinations of different types of infrastructure objects supported by the at least one cloud service provider is determined by performing a simple ratio approach, rotating priority approach or a combination thereof on the different types of infrastructure objects based on the cost budget.

12. A cost-driven method for determining an inventory layout comprising:
receiving a cost budget for provisioning infrastructure objects in a cloud computing environment provided by at least one cloud service provider;
performing a cost analysis of different types of infrastructure objects based on the received cost budget;
determining an inventory layout including a plurality of combinations of different types of infrastructure objects that are supported by the at least one cloud service provider based on the cost budget and the cost analysis; and
recommending, on a graphical user interface, a subset of combinations from the plurality of combinations of different types of infrastructure objects based on predetermined criteria.

13. The cost-driven method of claim 12, further comprising:
provisioning the infrastructure objects in the cloud computing environment based on a selection of one of the subset of combinations in accordance with the recommendation.

14. The cost-driven method of claim 12, wherein the infrastructure objects comprise servers, applications, or a combination thereof, wherein each server comprises physical resources selected from a group consisting of a central processing unit (CPU), memory, storage, and network resources, and wherein the applications comprise virtual machines (VMs).

15. The cost-driven method of claim 12, wherein determining the inventory layout including the plurality of combinations of different types of infrastructure objects, comprises:
determining the inventory layout including a plurality of combinations of different types of physical infrastructure that are supported by the at least one cloud service provider based on the cost budget, wherein the different types of physical infrastructure comprise different types of servers and associated versions to provide cloud computing services for applications running therein; and
determining the inventory layout including a plurality of combinations of instances of application blueprints that can be provisioned on the different types of servers by the at least one cloud service provider based on the cost budget.

16. The cost-driven method of claim 15, wherein the different types of servers are provided by different vendors.

17. The cost-driven method of claim 12, wherein determining an inventory layout including the plurality of combinations of different. types of infrastructure objects, comprises:
determining the inventory layout including a plurality of combinations of instances of application blueprints that can be provisioned on existing infrastructure in the cloud computing environment by the at least one cloud service provider based on the cost budget, wherein the existing infrastructure comprises servers provided by one or more vendors.

18. The cost-driven method of claim 12, wherein determining the inventory layout ding the plurality of combinations of different types of infrastructure objects comprises:
determining a capital cost and/or an operational cost associated with each of the different types of infrastructure objects based on a fully loaded cost of a cluster, direct VM cost, and storage cost, wherein the fully loaded cost of the cluster, the direct VM cost, and the storage cost are provided as an input from a user and/or read from a reference database; and
determining the inventory layout including the plurality of combinations of different types of infrastructure objects based on the cost analysis of the capital cost and/or the operational cost associated with each of the different types of infrastructure objects.

19. The cost-driven method of claim 18, wherein the fully loaded cost of the cluster comprises price per gigahertz (Ghz) of central processing units (CPUs), price per gigabyte (GB) of random-access memory (RAM), hardware cost, network cost, facilities cost, additional cost, or any combination thereof, and wherein the direct VM cost comprises operating system (OS) cost, VM labor cost, OS labor cost, backup cost or any combination thereof; and wherein the storage cost is a percentage of the GB that is required by VMs.

20. The cost-driven method of claim 12, wherein recommending the subset of combinations from the plurality of combinations of different types of infrastructure objects based on predetermined criteria, comprises:
de-duplicating the plurality of combinations; and
determining the subset of combinations from the de-duplicated plurality of combinations based on the predetermined criteria, wherein the predetermined criteria is selected from a group consisting of a predetermined priority, infrastructure utilization, and hybrid server configuration.

21. The cost-driven method of claim 12, wherein the plurality of combinations of different types of infrastructure objects supported by the at least one cloud service provider is determined by performing a simple ratio approach, rotating priority approach or a combination thereof on the different types of infrastructure objects based on the cost budget.

22. A non-transitory machine-readable medium storing instructions executable by a management server to:
receive a cost budget for provisioning infrastructure objects in a cloud computing environment provided by at least one cloud service provider;
determine an inventory layout including a plurality of combinations of different types of infrastructure objects that are supported by the at least one cloud service provider based on the cost budget; and
recommend, on a graphical user interface, a subset of combinations from the plurality of combinations of different types of infrastructure objects based on predetermined criteria.

23. The non-transitory machine-readable medium of claim 22, comprising instructions executable by the server to:
provision the infrastructure objects in the cloud computing environment based on a selection of one of the subset of combinations in accordance with the recommendation.

24. The non-transitory machine-readable medium of claim 22, wherein the infrastructure objects comprise servers, applications, or a combination thereof, wherein each server comprises physical resources selected from a group consisting of a central processing unit (CPU), memory, storage, and network resources, and wherein the applications comprise virtual machines (VMs).

25. The non-transitory machine-readable medium of claim 22, wherein determining the inventory layout including the plurality of combinations of different types of infrastructure objects, comprises:
determining the inventory layout including a plurality of combinations of different types of physical infrastructure that are supported by the at least one cloud service provider based on the cost budget, wherein the different types of physical infrastructure comprise different types of servers and associated versions to provide cloud computing services for applications running therein.

26. The non-transitory machine-readable medium of claim 25, wherein the plurality of combinations of different types of infrastructure is determined by performing a comparative analysis of vendors providing the different types of servers based on the cost budget.

27. The non-transitory machine-readable medium of claim 22, wherein determining the inventory layout including the plurality of combinations of different types of infrastructure objects, comprises:
determining the inventory layout including a plurality of combinations of instances of application blueprints that can be provisioned on existing infrastructure in the cloud computing environment by the at least one cloud service provider based on the cost budget, wherein the existing infrastructure comprises servers and associated versions provided by one or more vendors.

28. The non-transitory machine-readable medium of claim 22, wherein determining the inventory layout including the plurality of combinations of different types of infrastructure objects comprises:
determining a capital cost and/or an operational cost associated with each of the different types of infrastructure objects based on a fully loaded cost of a cluster, direct VM cost, and storage cost, wherein the fully loaded cost of the cluster, the direct VM cost, and the storage cost are provided as an input from a user and/or read from a reference database; and
determining the inventory layout including the plurality of combinations of different types of infrastructure objects based on a comparative analysis of the capital cost and/or the operational cost associated with each of the different types of infrastructure objects.

29. The non-transitory machine-readable medium of claim 28, wherein the fully loaded cost of the cluster comprises price per gigahertz (Ghz) of central processing units (CPUs), price per gigabyte (GB) of random-access memory (RAM), hardware cost, network cost, facilities cost, additional cost, or any combination thereof, and wherein the direct VM cost comprises operating system (OS) cost, VM labor cost, OS labor cost, backup cost or any combination thereof, and wherein the storage cost is a percentage of the GB that is required by VMs.

30. The non-transitory machine-readable medium of claim 22, wherein recommending the subset of combinations from the plurality of combinations of different types of infrastructure objects based on predetermined criteria, comprises:
de-duplicating the plurality of combinations, and
determining the subset of combinations from the de-duplicated plurality of combinations based on the predetermined criteria, wherein the predetermined criteria is selected from a group consisting of a predetermined priority, infrastructure utilization, and hybrid server configuration.
